(19) United States
(12) Patent Application Publication
(10) Pub. No.: US 2009/0309858 A1
(43) Pub. Date: Dec. 17, 2009

(54) LIQUID CRYSTAL DISPLAY AND DRIVING METHOD OF THE SAME

(75) Inventors: Sung Hun JIN, Seongnam-si (KR); Mun-Soo PARK, Suwon-si (KR); Gi-Chang LEE, Seoul (KR); Ki-Chan LEE, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/466,062

(22) Filed: May 14, 2009

(30) Foreign Application Priority Data
May 19, 2008 (KR) 10-2008-0046189

(51) Int. Cl. G09G 3/36; G02F 1/133; G09G 5/00

(52) U.S. Cl. 345/207; 349/116; 345/87

(57) ABSTRACT

A liquid crystal display (“LCD”) and a driving method of the same are provided. The LCD includes a photo sensor including a ring oscillator having cascade-connected inverters, wherein the output signal of the ring oscillator has a frequency varying according to the ambient luminance.

This application claims priority to Korean Patent Application No. 10-2008-0046189 filed on May 19, 2008, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”) and a driving method of the same, and more particularly, to a LCD including a photo sensor, and a driving method of the LCD.

2. Description of the Related Art

A liquid crystal display (“LCD”) includes an LCD panel comprising a first substrate, a second substrate, and a liquid crystal layer having dielectric anisotropy and interposed between the first and second substrates. In the LCD, an electric field is created between the first substrate and the second substrate, and the intensity of the electric field is adjusted, thereby controlling the amount of light passing through the LCD panel, thereby desired images are obtained. The LCD is not a self-emitting device. Hence, it may require a light source to provide back light to the LCD panel.

Recently, in order to improve display quality, LCDs capable of controlling the luminance of back light supplied from a light-emitting unit according to an image displayed on an LCD panel have been developed. Such an LCD includes a photo sensor for measuring the luminance of back light supplied from the light-emitting unit.

Meanwhile, development of LCDs having a touch screen function is under way. The LCD having a touch screen function is provided with an intuitive interface to allow users to easily enter information. One way of implementing the touch screen function is based on a photo sensing method. According to the photo sensing method, a plurality of photo sensors are arranged on a LCD, and a touch point is detected by sensing a difference in the luminance of incident light between the respective photo sensors depending on the touch of a finger.

In the LCD including the photo sensor for detecting the luminance of back light supplied from the light-emitting unit or having touch screen capability, the photo sensor generally outputs a signal in the form of voltage.

### BRIEF SUMMARY OF THE INVENTION

The present invention provides a liquid crystal display (“LCD”) including a photo sensor outputting a signal in the form of voltage and supplying a frequency-like output signal.

The present invention also provides a driving method of the LCD including a photo sensor outputting a signal in the form of voltage and supplying a frequency-like output signal.

The above and other objects of the present invention will be described in or be apparent from the following description of the preferred embodiments.

According to exemplary embodiments of the present invention, there is provided a LCD including a photo sensor including a ring oscillator having cascade-connected inverters, wherein an output signal of the ring oscillator has a frequency varying according to ambient luminance.

According to other exemplary embodiments of the present invention, there is provided a driving method of an LCD, the driving method including providing a LCD comprising a photo sensor including a ring oscillator having cascade-connected inverters, wherein an output signal of the ring oscillator has a frequency varying according to luminance of ambient light, supplying the ring oscillator with the ambient light, and measuring the luminance of ambient light using the frequency.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram for describing an exemplary liquid crystal display (“LCD”) and an exemplary method of driving the same according to an exemplary embodiment of the present invention;

FIG. 2 is an equivalent circuit diagram of a single pixel included in an exemplary LCD panel illustrated in FIG. 1;

FIG. 3 is a detailed block diagram of an exemplary image signal control unit illustrated in FIG. 1;

FIG. 4 is a block diagram of an exemplary light data signal control unit illustrated in FIG. 1;

FIG. 5 is a circuit diagram illustrating operations of an exemplary backlight driver and an exemplary light-emitting block illustrated in FIG. 1;

FIG. 6 is a block diagram for describing an exemplary light measuring portion illustrated in FIG. 1;

FIG. 7 is a circuit diagram for describing an exemplary photo sensor illustrated in FIG. 6 and an exemplary frequency recognizing circuit;

FIG. 8 is a cross-sectional view of an exemplary LCD panel for describing each exemplary inverter illustrated in FIG. 7;

FIGS. 9A and 9B are equivalent circuit diagrams of an exemplary inverter illustrated in FIG. 8;

FIG. 10 is a graph illustrating input-output voltage transmission characteristics of the exemplary inverters illustrated in FIG. 8 depending on the luminance of ambient light;

FIGS. 11A and 11B illustrate output signals of the exemplary photo sensor illustrated in FIG. 7 relative to the ambient luminance with varying the ambient light;

FIG. 12 is a graph illustrating a relationship between the ambient luminance and the frequency of output signals of the exemplary photo sensor illustrated in FIG. 7;

FIG. 13 is a block diagram for describing an exemplary LCD and an exemplary method of driving the LCD according to another exemplary embodiment of the present invention;

FIG. 14 is a detailed block diagram of an exemplary image signal control unit illustrated in FIG. 13;

FIG. 15 is a block diagram of an exemplary read-out portion illustrated in FIG. 13; and

FIG. 16 is a cross-sectional view of an exemplary LCD panel for describing each exemplary inverter illustrated in FIG. 13.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Spatially relative terms, such as “below,” “beneath,” “lower,” “above,” “upper,” and the like, may be used herein for ease of description to describe one device or element's relationship to another device(s) or element(s) as illustrated in the drawings. It will be understood that the spatially relative terms are intended to encompass different orientations of the device in use or operation in addition to the orientation depicted in the drawings.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

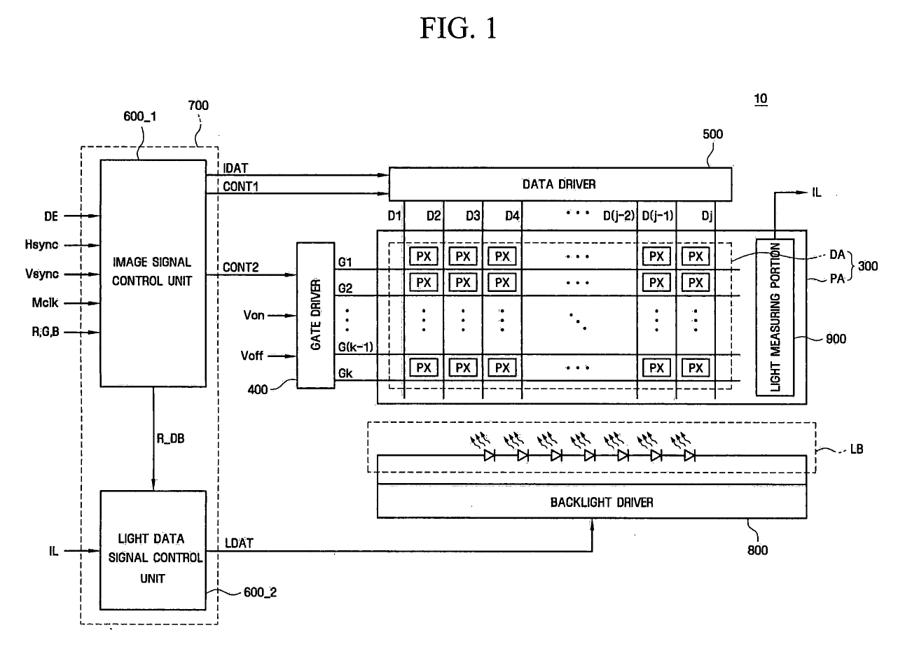

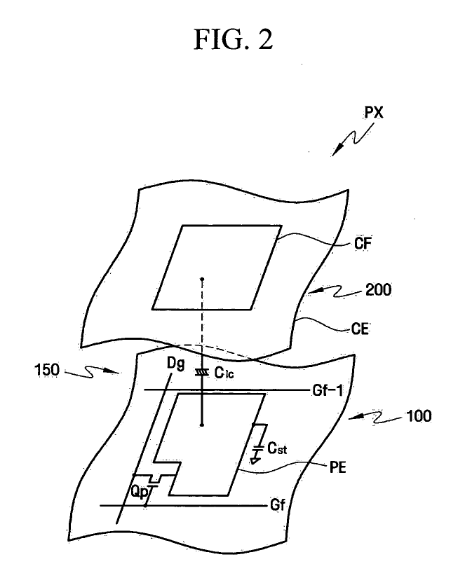

A liquid crystal display (“LCD”) according to an embodiment of the present invention and a driving method thereof will now be described with reference to FIGS. 1 through 12. FIG. 1 is a block diagram for describing an LCD 10 and an exemplary method of driving the same according to an exemplary embodiment of the present invention, and FIG. 2 is an equivalent circuit diagram of a single pixel included in an exemplary LCD panel 300 illustrated in FIG. 1.

Referring to FIG. 1, the LCD 10 includes an LCD panel 300 having a display area DA in which an image is displayed and a peripheral area PA in which a light measuring portion 900 is mounted and partly formed, a signal controller 700, a gate driver 400, a data driver 500, a backlight driver 800, and a light-emitting unit LB, also termed a light-emitting block LB, connected to the backlight driver 800. Although, FIG. 1 shows that all portions of the light measuring portion 900 is formed in the peripheral area PA, the invention is not limited to the illustrated example, only some portion of the light measuring portion 900 is formed in the peripheral area PA and the other portion of the light measuring portion 900 is formed in outer of the LCD panel 300.

The LCD panel 300 includes a plurality of gate lines G1-Gk, a plurality of data lines D1-Dj, and a plurality of pixels PX. The gate lines G1-Gk may extend in a first direction and the data lines D1-Dj may extend in a second direction crossing the first direction. The first and second directions may be perpendicular. The pixels PX may be arranged in a matrix form relative to the gate lines G1-Gk and the data lines D1-Dj. In an exemplary embodiment, each pixel PX may be defined at an intersection area of each of the gate lines G1-Gk and each of the plurality of data lines D1-Dj. Although not shown, the plurality of pixels PX may be divided into red subpixels, green subpixels, and blue subpixels, respectively.

FIG. 2 is an equivalent circuit diagram of a pixel. A pixel, e.g., a pixel PX connected to an fth gate line Gf (f=1˜k) and a gth data line Dg (g=1˜j), includes a switching element Qp connected to the gate line Gf and the data line Dg, and a liquid crystal capacitor C_{lc} and a storage capacitor Cₛₜ. The liquid crystal capacitor C_{lc} includes two electrodes, for example, a pixel electrode PE of a first substrate 100, a common electrode CE of a second substrate 200, and liquid crystal molecules 150 interposed between the first and second substrates 100 and 200. A color filter CF may be formed at a portion of the common electrode CE. Alternatively, a color filter may be formed on the first substrate 100. Alternatively, a common electrode CE also may be formed on the first substrate 100.

Referring again to FIG. 1, the LCD panel 300 may be divided into a display area DA in which an image is displayed and a peripheral area PA in which an image is not displayed.

The display area DA includes the plurality of pixels PX, and each pixel PX displays an image in response to an image data voltage supplied from the data driver 500.

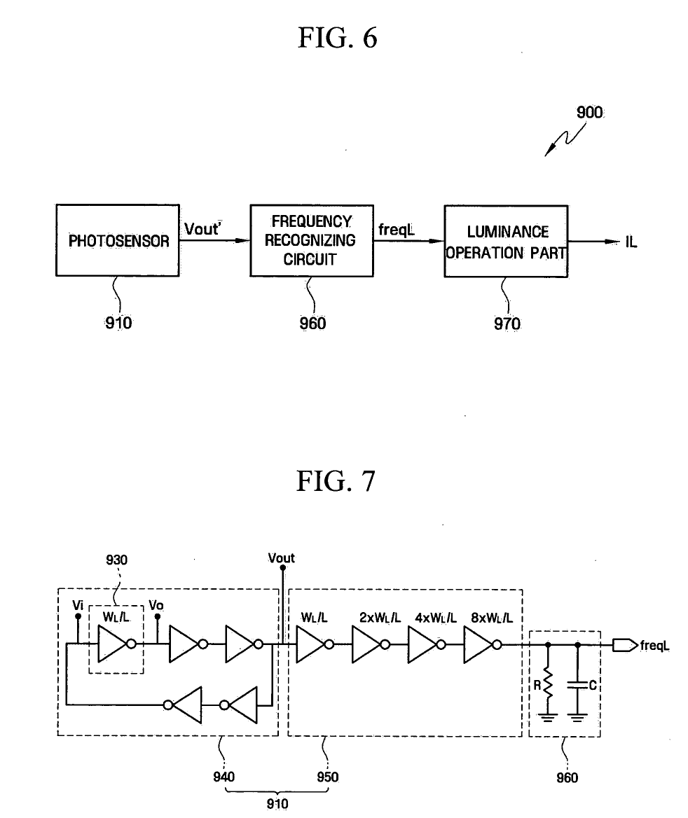

The peripheral area PA is a non-display area in which an image is not displayed A light measuring portion 900 may be mounted and partly formed in the peripheral area PA. The light measuring portion 900 measures the luminance of back light supplied from the light-emitting block LB to output a measured back light luminance IL to the signal controller 700. The light measuring portion 900 will later be described with reference to FIG. 5.

The signal controller 700 receives external control signals Vsync, Hsync, Mclk, DE, first image signals (R, G, and B), and the measured back light luminance IL, and outputs a second image data signal IDAT, a data control signal CONT1, a gate control signal CONT2, and a light data signal LDAT.

In detail, the signal controller 700 may convert a first image signal R, G, B into a second image data signal IDAT and output the same. In addition, the signal controller 700 may receive the measured back light luminance IL of back light, as measured by the light-emitting unit LB, and supply a light data signal LDAT to compensate for the measured back light luminance IL to the backlight driver 800.

The signal controller 700 may be functionally divided into an image signal control unit 600_1 and a light data signal control unit 600_2. The image signal control unit 600_1 controls the image displayed on the LCD panel 300, while the light data signal control unit 600_2 controls the operation of the backlight driver 800. The image signal control unit 600_1 and the light data signal control unit 600_2 may be physically separated from each other.

In detail, the image signal control unit 600_1 receives a first image signal R, G, B and outputs a second image data signal IDAT corresponding to the received first image signal R, G, B.

The image signal control unit 600_1 may also receive external control signals Vsync, Hsync, Mclk, and DE, and generate a data control signal CONT1 and a gate control signal CONT2. Examples of the external control signals include a vertical synchronization signal Vsync, a horizontal synchronization signal Hsync, a main clock signal MCLK, and a data enable signal DE. The data control signal CONT1 is used to control the operation of the data driver 500, and the gate control signal CONT2 is used to control the operation of the gate driver 400.

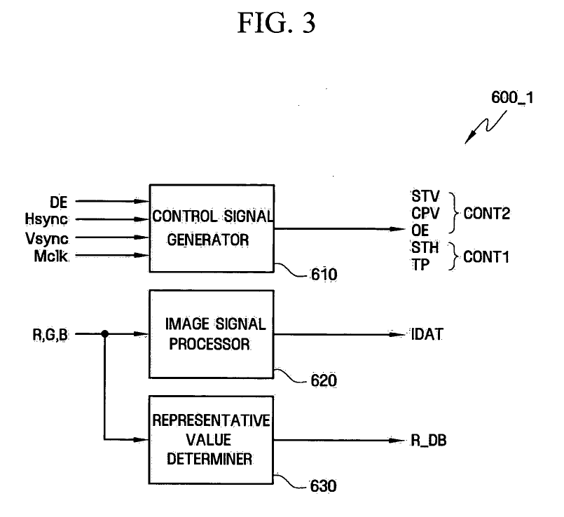

In addition, the image signal control unit 600_1 may receive the first image signal (R,G,B), output a representative image signal R_DB, and supply the same to the light data signal control unit 600_2. The image signal control unit 600_1 will be described below in more detail with reference to FIG. 3.

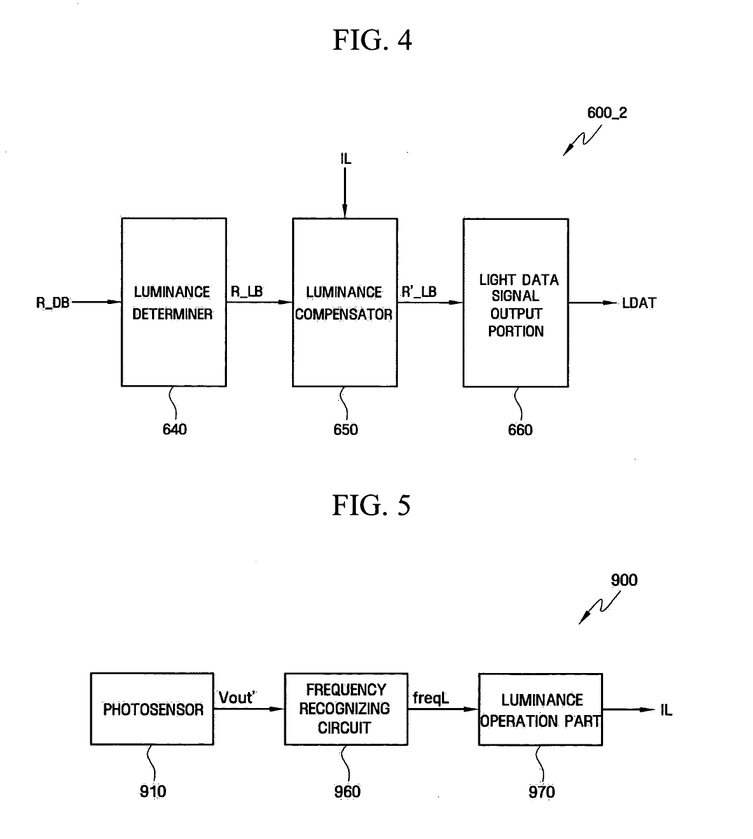

The light data signal control unit 600_2 may receive the representative image signal R_DB and the measured back light luminance IL and supply a light data signal LDAT to the backlight driver 800. The light data signal control unit 600_2 will be described below in more detail with reference to FIG. 4.

The gate driver 400, provided with the gate control signal CONT2 from the image signal control unit 600_1, applies a gate signal to the gate lines G1-Gk. Here, the gate signal is comprising a gate-on voltage Von and a gate-off voltage Voff, which are generated from a gate on/off voltage generator (not shown). The gate control signal CONT2 for controlling the operation of the gate driver 400 includes a vertical synchronization start signal instructing start of the operation of the gate driver 400, a gate clock signal controlling an output timing of the gate on signal, an output enable signal that determines a pulse width of the gate-on voltage Von, etc.

The data driver 500 receives the data control signal CONT1 from the image signal control unit 600_1 and applies a voltage corresponding to the second image data signal IDAT to the data lines D1-Dj. The voltage corresponding to the second image data signal IDAT may be a voltage supplied from a gray voltage generator (not shown) according to grayscales of the second image data signal IDAT. That is to say, the voltage may be obtained by dividing a driving voltage of the gray voltage generator according to the grayscales of the second image data signal IDAT. The data control signal CONT1 includes signals for controlling the operation of the data driver 500. The signals for controlling the operation of the data driver 500 include a horizontal synchronization start signal for starting the operation of the data driver 500, an output enable signal that determines the output of an image data voltage, etc.

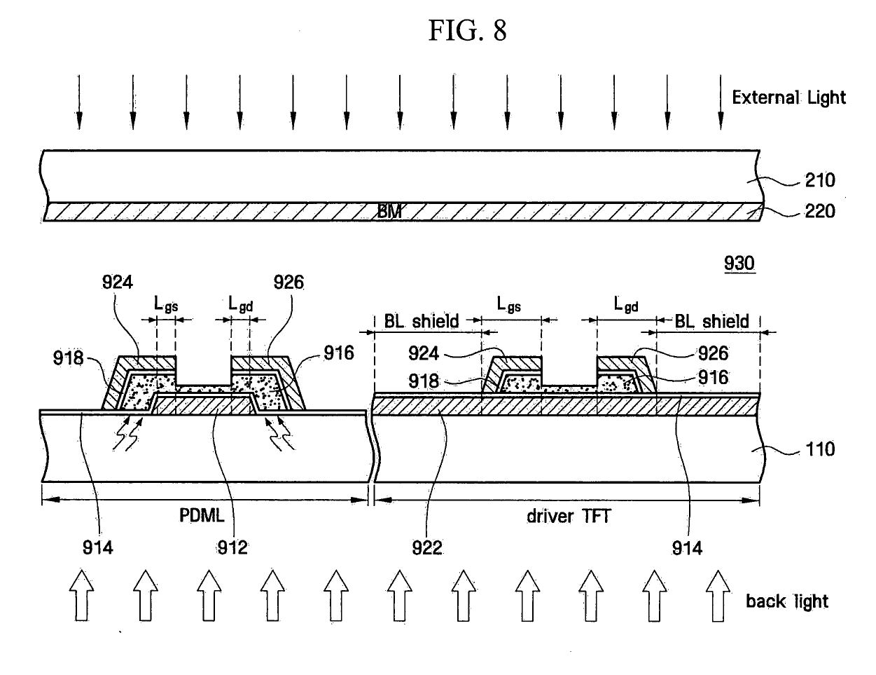

The backlight driver 800 adjusts luminance of back light supplied from the light-emitting block LB in response to the light data signal LDAT. The luminance of back light supplied from the light-emitting block LB may vary according to a duty ratio of the light data signal LDAT. The internal structure and operation of the backlight driver 800 will later be described in more detail with reference to FIG. 6.

The light-emitting block LB may include at least one light source and provides back light to the LCD panel 300. For example, the light-emitting block LB may include a light-emitting diode (“LED”), i.e., a point light source, as shown. However, in alternative exemplary embodiments, the light source may be a line light source, or a surface light source. The luminance of back light supplied from the light-emitting block LB may be controlled by the backlight driver 800 connected to the light-emitting block LB.

FIG. 3 is a detailed block diagram of an exemplary image signal control unit 600_1 illustrated in FIG. 1.

Referring to FIG. 3, the image signal control unit 600_1 includes a control signal generator 610, an image signal processor 620, and a representative value determiner 630.

The control signal generator 610 receives the external control signals Vsync, Hsync, Mclk, and DE and outputs the data control signal CONT1 and the gate control signal CONT2. In detail, the control signal generator 610 may generate various signals, such as a vertical start signal STV for starting the operation of the gate driver 400 shown in FIG. 1, a gate clock CPV for determining an output time of the gate-on voltage Von, a gate output enable signal OE for determining a pulse width of the gate-on voltage Von, a horizontal synchronization start signal STH for starting the operation of the data driver 500 shown in FIG. 1, and an output instruction signal TP for instructing the output of an image data voltage.

The image signal processor 620 may receive first image signals R, G, B and outputs second image data signals IDAT corresponding to the received first image signals R, G and B. The second image data signals IDAT may be signals converted from the first image signals R, G and B for improving display quality, for example, overdriving. A detailed explanation about the operation of overdriving will not be given herein.

The representative value determiner 630 determines a representative image signal R_DB displayed on the LCD panel 300. For example, the representative value determiner 630 may receive the first image signals R, G, and B and determine the representative image signal R_DB. The representative image signal R_DB may be an average value of the first image signals R, G, and B. Thus, the representative image signal R_DB may indicate an average luminance value of the image displayed on the LCD panel 300.

FIG. 4 is a block diagram of an exemplary light data signal control unit 600_2 illustrated in FIG. 1.

Referring to FIGS. 1 and 4, the light data signal control unit 600_2 includes a luminance determiner 640, luminance compensator 650, and a light data signal output portion 660.

The luminance determiner 640 receives the representative image signal R_DB, determines a native luminance R_LB of back light corresponding to the representative image signal R_DB, and outputs the native luminance R_LB of back light to the luminance compensator 650. The luminance determiner 640 may determine the native luminance R_LB of back light using, for example, a look-up table (not shown).

The luminance compensator 650 receives the native luminance R_LB and measured back light luminance IL of the backlight, and supplies compensated luminance R′_LB to the light data signal output portion 660. The compensated luminance R′_LB is a luminance value obtained by compensating for the native luminance R_LB until the measured back light luminance IL of the back light reaches a desired level.

In detail, the luminance compensator 650 compares the native luminance R_LB of backlight with the measured back light luminance IL thereof. If the measured back light luminance IL is smaller than the native luminance R_LB, the luminance compensator 650 generates the compensated luminance R′_LB, which is greater than the native luminance R_LB. For example, in a case where a light-emitting device including the light-emitting unit LB deteriorates, the luminance of backlight supplied from the light-emitting unit LB may be lower than a desired luminance value. In this case, compensation can be made to achieve a desired level of backlight supplied from the light-emitting unit LB by providing the compensated luminance R′_LB greater than the native luminance R_LB. Conversely, if the measured back light luminance IL is greater than the native luminance R_LB, the luminance compensator 650 generates the compensated luminance R′_LB, which is smaller than the native luminance R_LB.

The light data signal output portion 660 outputs the light data signal LDAT according to the compensated luminance R′_LB generated from the luminance compensator 650. The light data signal LDAT corresponding to the compensated luminance R′_LB is supplied to the backlight driver 800, thereby compensating the luminance of back light supplied from the light-emitting unit LB.

FIG. 5 is a circuit diagram illustrating operations of the exemplary backlight driver 800 and the exemplary light-emitting block LB illustrated in FIG. 1.

Referring to FIG. 5, the backlight driver 800, including a switching element BLQ, controls luminance of the light-emitting block LB in response to the light data signal LDAT.

The backlight driver 800 operates as follows. When the light data signal LDAT is activated to a high level, the switching element BLQ of the backlight driver 800 is turned on and a power supply voltage Vin is supplied to the light-emitting block LB. Accordingly, current flows through the light-emitting block LB and an inductor L. Here, the inductor L stores the energy derived from the current. When the light data signal LDAT is deactivated to a low level, the switching element BLQ is turned off, creating a closed circuit constituted by the light-emitting block LB, the inductor L, and a diode D, so that current flows therethrough. As the energy stored in the inductor L is discharged, the quantity of current is reduced. Since a time taken for the switching element BLQ to be turned on is adjusted according to the duty ratio of the light data signal LDAT, the luminance of the light-emitting block LB can be controlled.

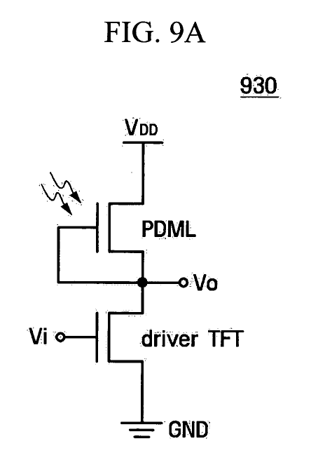

FIG. 6 is a block diagram for describing the exemplary light measuring portion 900 illustrated in FIG. 1, and FIG. 7 is a circuit diagram for describing the exemplary photo sensor 910 illustrated in FIG. 6 and an exemplary frequency recognizing circuit 960. For the convenience of explanation, the frequency recognizing circuit 960 will be described as equivalent circuit diagram of the R-C loading effect of the frequency recognizing circuit 960. However, the present invention is not limited thereto.

Referring to FIGS. 6 and 7, the light measuring portion 900 includes a photo sensor 910 that outputs an output signal Vout′ having a frequency varying according to the luminance of light surrounding a ring oscillator, a frequency recognizing circuit 960 that recognizes a frequency of the output signal Vout′, and a luminance operation part 970 that outputs the measured back light luminance IL.

The photo sensor 910 which is form on the first substrate, includes a ring oscillator 940 having a plurality of cascade-connected inverters 930, and an output buffer 950 transmitting the output signal Vout of the ring oscillator 940.

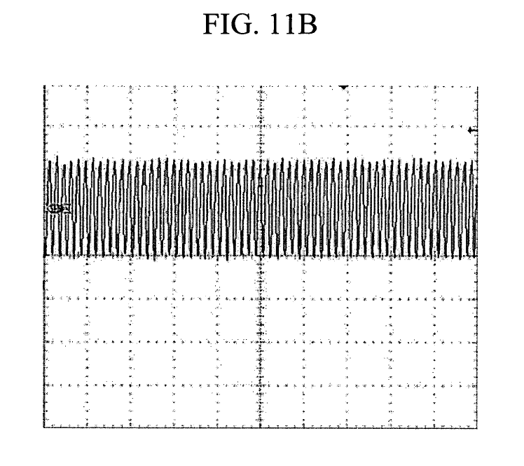

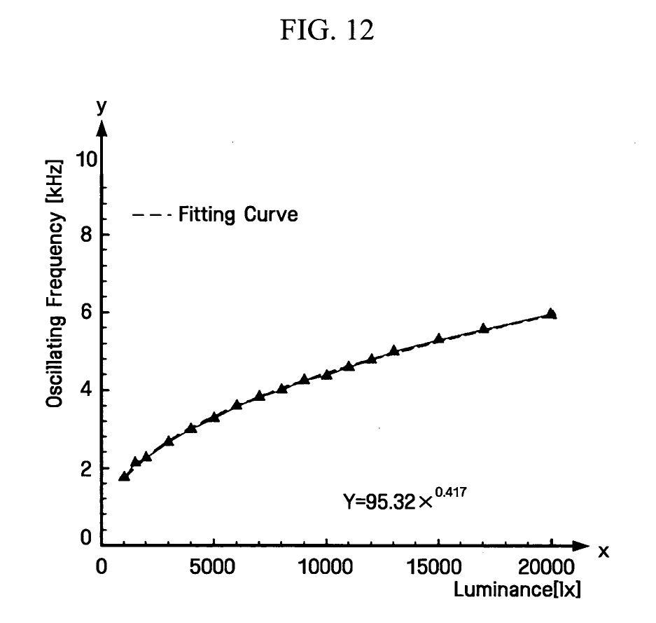

The plurality of inverters 930 of the ring oscillator 940 may include an odd number of inverters. An output voltage Vo of one of the plurality of inverters 930 is applied to the next inverter 930 as an input voltage Vi. In this case, the output signal Vout of the ring oscillator 940 has an oscillated waveform. The oscillated waveform of the output signal Vout of the ring oscillator 940 has a frequency varying according to the ambient luminance, which will later be described in more detail with reference to FIGS. 11A through 12.

The output buffer 950 transmits the output signal Vout of the ring oscillator 940 to the frequency recognizing circuit 960. The output buffer 950 can reduce a load effect, which may be generated when the frequency recognizing circuit 960 shown in FIG. 7 as an RC primary equivalent circuit is connected to the ring oscillator 940.

The output buffer 950 also amplifies the output signal Vout from the ring oscillator 940 for transmission to the frequency recognizing circuit 960. For example, in transistors of the plurality of inverters 930 included in the ring oscillator 940, active areas may have width to length ratios (WL/L). And in transistors of each of the plurality of inverters included in the output buffer 950, active areas may have width to length ratios as represented by WL/L, 2×WL/L, 4×WL/L, 8×WL/L, respectively.

The frequency recognizing circuit 960 recognizes a frequency of the output signal Vout′ of the photo sensor 910, and supplies the recognized frequency freqL of the output signal Vout′ to the luminance operation part 970. The frequency recognizing circuit 960 may be, for example, a phase locking loop (“PLL”) circuit. A detailed explanation about the PLL circuit will not be given.

The luminance operation part 970 calculates the luminance of light surrounding the ring oscillator 940 using the frequency freqL of the output signal Vout′, and outputs measured backlight luminance IL.

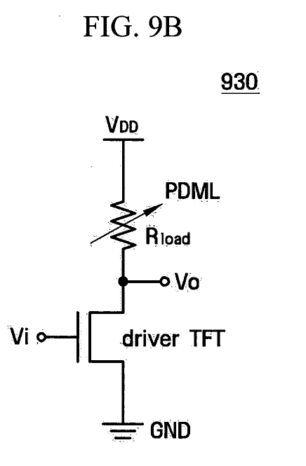

FIG. 8 is a cross-sectional view of an exemplary LCD panel (300 of FIG. 1) for describing each exemplary inverter 930 illustrated in FIG. 7.

Referring to FIG. 8, a first transistor PDML and a second transistor driver TFT are formed on an insulating substrate 110 included in the first substrate (100 of FIG. 2) of the LCD panel 300. A light-shielding portion 220 is formed on an insulating substrate 210 included in the second substrate (200 of FIG. 2) of the LCD panel 300.

External light is incident from above the ring oscillator (940 of FIG. 7), that is, above the first transistor PDML and the second transistor driver TFT, while backlight is incident from below the lower ring oscillator 940, that is, below the first transistor PDML and the second transistor driver TFT, from the light-emitting unit (LB of FIG. 1). Throughout the specification, the term “ambient light” is used to embrace both external light and back light.

Referring to FIG. 8, each of the plurality of inverters 930 included in the ring oscillator 940 illustrated in FIG. 7 includes a first transistor PDML having an active layer 916 into which ambient light is incident, and a second transistor driver TFT having an active layer 916 by which ambient light is shielded.

The first transistor PDML and the second transistor driver TFT include gate electrodes 912 and 922, active layers 916 disposed over the gate electrodes 912, 922, and source electrodes 924 and drain electrodes 926 disposed over the active layers 916, respectively.

A portion of the active layer 916 of the first transistor PDML has a non-overlapping area that does not partially overlap with the gate electrode 912, while the active layer 916 of the second transistor driver TFT completely overlaps with the gate electrode 922. In other words, the gate electrode 912 does not completely shield the active layer 916 of the first transistor PDML from backlight, while the active layer 916 of the second transistor driver TFT is completely shielded by the gate electrode 922. Accordingly, back light is incident into the active layer 916 of the first transistor PDML, while back light is shielded by the gate electrode 922 in the second transistor driver TFT, thereby preventing the back light from entering the active layer 916 of the second transistor driver TFT.

In order to ensure back light to be sufficiently incident into the active layer 916 of the first transistor PDML, an overlap length Lgs of the gate electrode 912 and the source electrode 924 and an overlap length Lgd of the gate electrode 912 and the drain electrode 926 may be minimums necessary to acquire processing margins, respectively.

On the other hand, in order to further suppress back light from entering the active layer 916 of the second transistor driver TFT, the gate electrode 922 of the second transistor driver TFT may include a BL shield area extending from the active layer 916 by over 10 μm.

Meanwhile, the light-shielding portion 220 for shielding external light is formed over the first transistor PDML and the second transistor driver TFT. The light-shielding portion 220 may be, for example, a black matrix BM. In this manner, it is possible to prevent external light from entering the active layer 916 of the first transistor PDML and the active layer 916 of the second transistor driver TFT.

A method of fabricating the first transistor PDML and the second transistor driver TFT will now be described.

First, a metal layer to be gate electrodes 912 and 922 is deposited on the insulating substrate 110 and patterned to form the gate electrodes 912 and 922. Subsequently, a gate insulating layer 914, the active layer 916, and an ohmic contact layer 918 are sequentially deposited on the gate electrodes 912 and 922 and patterned. Next, a metal layer to be a source electrode 924 and a drain electrode 926 is deposited and patterned to form the source electrode 924 and the drain electrode 926 for each transistor.

In order to fabricate the first transistor PDML and the second transistor driver TFT, the general method of fabricating a thin film transistor (“TFT”) indicated as the switching element Qp in FIG. 2 can be utilized.

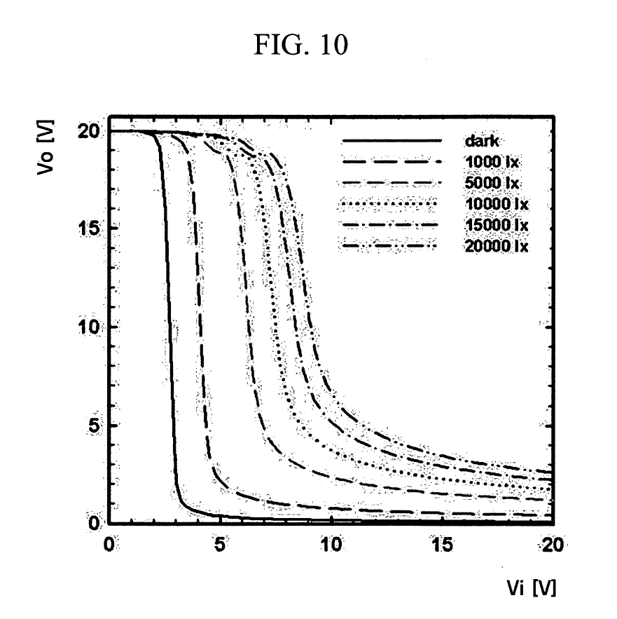

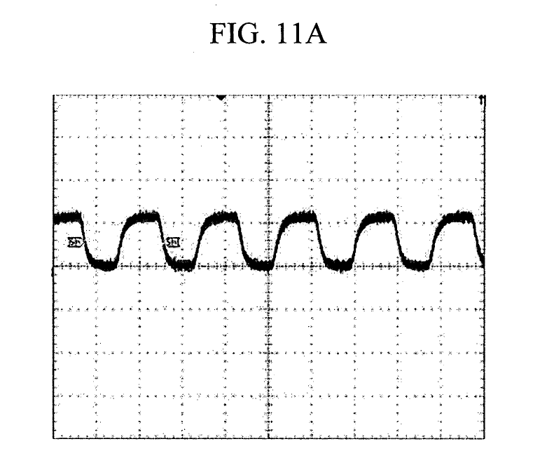

FIGS. 9A and 9B are equivalent circuit diagrams of the exemplary inverters 930 illustrated in FIG. 8, and FIG. 10 is a graph illustrating input-output voltage transmission characteristics of the exemplary inverters 930 illustrated in FIG. 8 depending on the ambient luminance.

Referring to FIG. 9A, each inverter 930 illustrated in FIG. 8 includes a first transistor PDML and a second transistor driver TFT, which are serially connected to each other.

A power supply voltage Vdd is applied to a drain electrode of the first transistor PDML, and a source electrode of the second transistor driver TFT is connected to a ground terminal GND. An input voltage Vi is applied to a gate electrode of the second transistor driver TFT, and an output voltage Vo is output from a terminal commonly connected to a gate electrode of the first transistor PDML and a source electrode of the first transistor PDML. The terminal is also connected to a drain electrode of the second transistor driver TFT.

If back light is incident into an active layer of the first transistor PDML, optical current increases in proportion to the luminance of back light. Since the flow of optical current also occurs when a gate-source voltage Vgs is 0 V, the first transistor PDML may serve like a depletion mode TFT. In addition, the first transistor PDML operates in a saturated area. As ambient luminance, that is, the luminance of back light, becomes higher, drain current is increased. Accordingly, the first transistor PDML can be represented as variable resistance Rload that varies according to the ambient luminance, as shown in FIG. 9B.

As described above, the first transistor PDML serves like a depletion mode TFT that operates in a depletion mode according to the ambient light, that is, back light. That is to say, the first transistor PDML may be termed a pseudo depletion mode load. Meanwhile, the second transistor driver TFT is a driver TFT that operates in an incremental mode.

Referring to FIG. 10, the voltage transfer characteristic of each inverter 930 may differ according to the ambient luminance. In other words, the higher the ambient luminance, the greater the noise margin for a low-level input.

FIGS. 11A and 11B illustrate output signals Vout′ of the exemplary photo sensor 910 illustrated in FIG. 7 relative to the ambient luminance with varying the ambient light, and FIG. 12 is a graph illustrating a relationship between the ambient luminance and the frequency of output signals of the exemplary photo sensor 910 illustrated in FIG. 7.

The respective output signals Vout′ shown in FIGS. 11A and 11B were measured under conditions of a power supply voltage (VDD of FIG. 9A) being 20 V, and an operating temperature being about 50° C., which is generally known as the internal driving temperature of the LCD panel (300 of FIG. 1). FIG. 11A shows that when the luminance of back light is 1,000 lx, the measured oscillation frequency is 1.376 KHz. FIG. 11B shows that when the luminance of back light is 20,000 lx, the measured oscillation frequency is 5.963 KHz.

Like FIGS. 11A and 11B, FIG. 12 illustrates a measurement result of the oscillating frequency of output signals Vout′ while varying the luminance of back light.

The measurement result can be approximated as the fitting curve shown in FIG. 12. A relationship between the frequency (y) of the output signal Vout′ and the ambient luminance (x) can be derived from the fitting curve. That is to say, the frequency (y) of the output signal Vout′ is proportional to the power of a real number of the ambient luminance (x). As shown in FIG. 12, the frequency (y) of the output signal Vout′ is modeled to have a value obtained by multiplying 95.32 to the 0.417^{th} power of the ambient luminance (x), that is, y=95.32·x^{0.417}. In such a manner, the relationship between the frequency (y) of the output signal Vout′ and the ambient luminance (x) can be easily modeled. Therefore, the ambient luminance (x) can be obtained from the frequency (y) of the output signal Vout′.

In the LCD according to an exemplary embodiment of the present invention and the driving method thereof, the output signal of a photo sensor has a frequency form. Therefore, the output signal can be simply converted into a digital code. In addition, since the frequency-form output signal is robust against noise, it can be transmitted over a long distance while reducing distortion due to noise, thereby improving the reliability of the photo sensor.

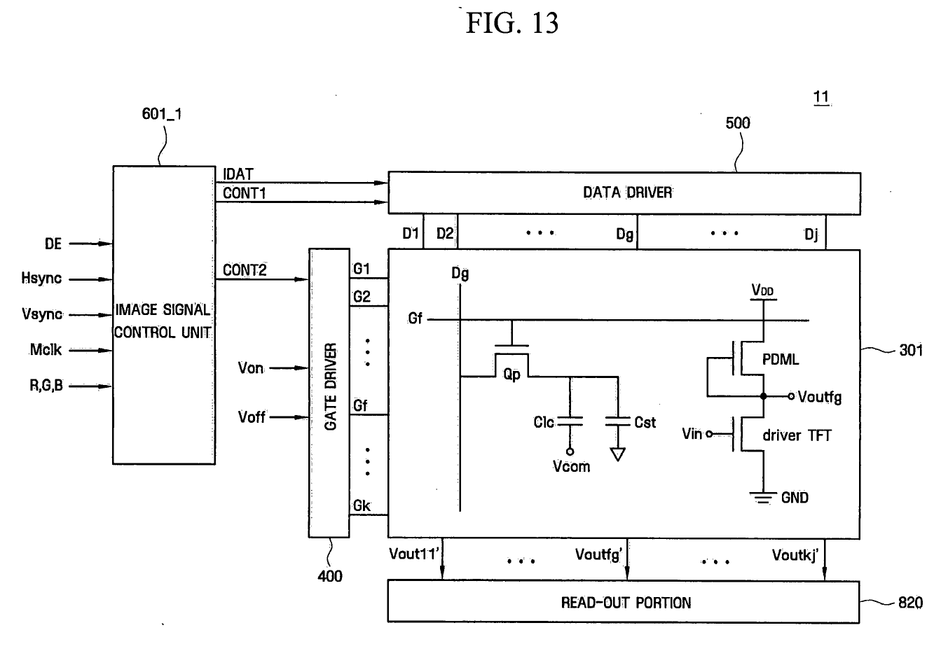

Next, an exemplary LCD 11 according to another exemplary embodiment of the present invention will be described with reference to FIGS. 13 through 16. The same components as those in the previous exemplary embodiment are identified by the same reference numerals. For convenience of description, detailed descriptions about the identical elements will be omitted.

FIG. 13 is a block diagram for describing an exemplary LCD 11 and a method of driving the LCD according to another exemplary embodiment of the present invention.

Referring to FIG. 13, the LCD 11 includes a touch screen display panel 301, an image signal control unit 601_1, a gate driver 400, a data driver 500, and a read-out portion 820.

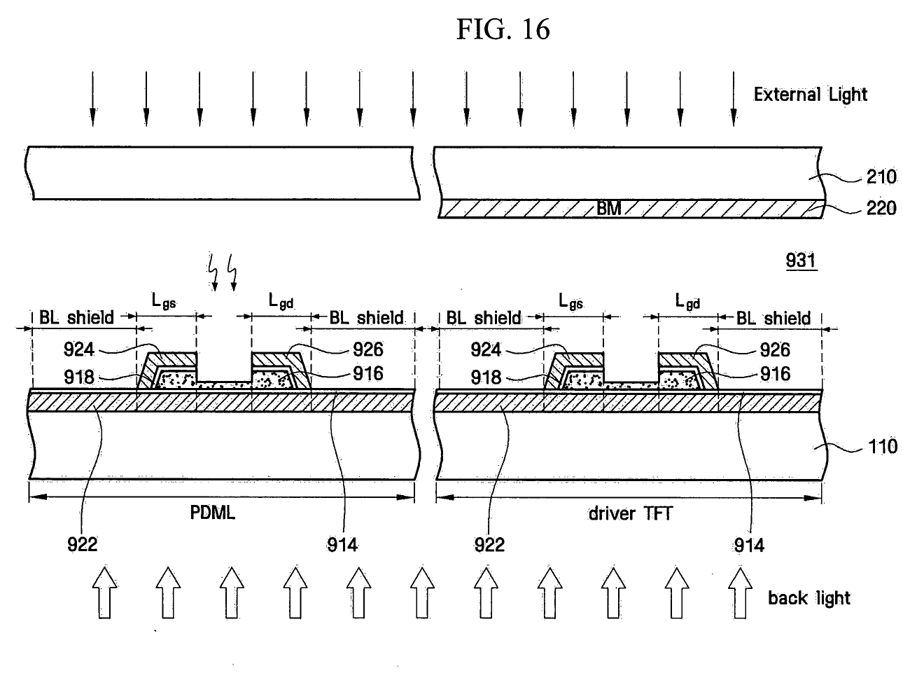

Referring to FIG. 13, the touch screen display panel 301 includes a plurality of gate lines G1-Gk, a plurality of data lines D1-Dj, a plurality of pixels PX, and a plurality of photo sensors, including inverters 931 as shown in FIG. 16. As to the number of the photo sensors, as many photo sensors as the plurality of pixels PX, for example, may be arranged, and each photo sensor respectively generates output signals Vout11′-Voutkj′.

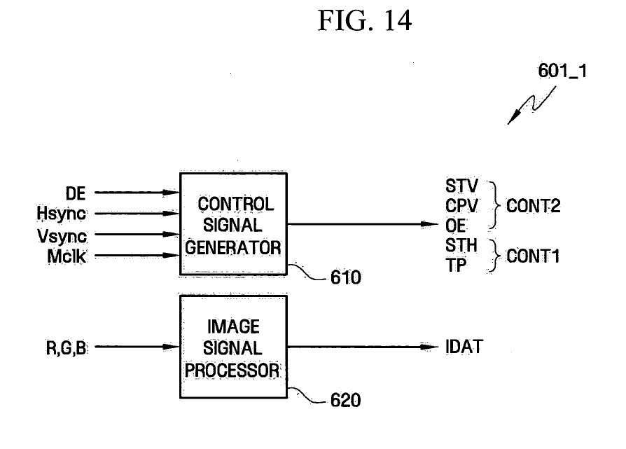

FIG. 14 is a detailed block diagram of the exemplary image signal control unit illustrated in FIG. 13.

Referring to FIG. 14, the image signal control unit 601_1 includes a control signal generator 610 and an image signal processor 620. The control signal generator 610 generates the gate control signal CONT2 and the data control signal CONT1, and the image signal processor 620 generates the second image data signal IDAT.

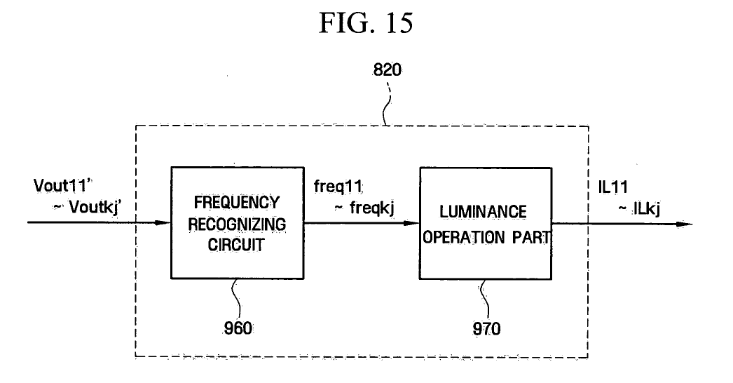

FIG. 15 is a block diagram of an exemplary read-out portion illustrated in FIG. 13.

Referring to FIGS. 13 and 15, a read-out portion 820 receives output signals Vout11′-Voutkj′ from the respective photo sensors, and outputs read-out signals IL11-ILkj containing information about whether the respective photo sensors are touched or not.

The read-out portion 820 includes a frequency recognizing circuit 960 and a luminance operation part 970. The frequency recognizing circuit 960 recognizes frequencies freq11-freqkj of the output signals Vout11′-Voutkj′ output from the respective photo sensors and supplies the same to the luminance operation part 970. The luminance operation part 970 calculates ambient luminance values of the respective photo sensors 931 using the frequencies freq11-freqkj of the output signals Vout11′-Voutkj′, and outputs the read-out signals IL11-ILkj.

In an alternative exemplary embodiment, the read-out portion 820 may include only a frequency recognizing circuit 960 (not shown). In this case, the LCD 11 is capable of determining whether the respective photo sensors are touched or not based on only a difference between the frequencies freq11-freqkj of the output signals Vout11′-Voutkj′.

FIG. 16 is a cross-sectional view of an exemplary LCD panel for explaining each exemplary inverter 931 illustrated in FIG. 13.

Referring to FIG. 16, the inverter 931 includes a first transistor PDML having an active layer 916 into which ambient light is incident, and a second transistor driver TFT having an active layer 916 by which ambient light is shielded.

Active layers 916 of the first transistor PDML and the second transistor driver TFT are completely overlapped with the gate electrode 922. Therefore, the gate electrode 922 shields the back light, thereby preventing the back light from entering the active layers 916 of the first transistor PDML and the second transistor driver TFT.

In order to further suppress the back light from entering the active layers 916 of the first transistor PDML and the second transistor driver TFT, the gate electrode 922 of the second transistor driver TFT may include a BL shield area extending from the active layer 916 by over 10 μm.

Meanwhile, the light-shielding portion 220 for shielding external light is formed over the second transistor driver TFT, but not over the first transistor PDML. The light-shielding portion 220 may be, for example, a black matrix BM. Therefore, external light is incident into the active layer 916 of the first transistor PDML, but not incident into the active layer 916 of the second transistor driver TFT.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A liquid crystal display comprising a photo sensor including a ring oscillator having cascade-connected inverters, wherein an output signal of the ring oscillator has a frequency varying according to ambient luminance.

2. The liquid crystal display of claim 1, wherein each of the inverters includes a first transistor having an active layer into which ambient light is incident, and a second transistor having an active layer by which ambient light is shielded.

3. The liquid crystal display of claim 1, wherein the inverters comprise an odd number of inverters.

4. The liquid crystal display of claim 1, wherein each of the inverters includes a first transistor and a second transistor, which are serially connected to each other, a power supply voltage is applied to a drain electrode of the first transistor and a source electrode of the second transistor is connected to a ground terminal, an input voltage Vi is applied to a gate electrode of the second transistor, and an output voltage is output from a terminal commonly connected to a gate electrode of the first transistor, a source electrode of the first transistor and a drain electrode of the second transistor.

5. The liquid crystal display of claim 1, further comprising an output buffer transmitting the output signal of the ring oscillator.

6. The liquid crystal display of claim 5, wherein the output buffer amplifies the output signal for transmission.

7. The liquid crystal display of claim 6, wherein the output buffer comprises a plurality of inverters which are serially connected to each other.

8. The liquid crystal display of claim 7, wherein each of the inverters includes a first transistor and a second transistor, which are serially connected to each other, a power supply voltage is applied to a drain electrode of the first transistor and a source electrode of the second transistor is connected to a ground terminal, an input voltage Vi is applied to a gate electrode of the second transistor, and an output voltage is output from a terminal commonly connected to a gate electrode of the first transistor, a source electrode of the first transistor and a drain electrode of the second transistor.

9. The liquid crystal display of claim 1, wherein the frequency of the output signal is proportional to a power of a real number of the ambient luminance.

10. The liquid crystal display of claim 1, further comprising a light-emitting unit supplying back light from below the ring oscillator, wherein each of the inverters includes a first transistor and a second transistor, each having a gate electrode, an active layer disposed over the gate electrode, and a source electrode and a drain electrode disposed on the active layer, the active layer of the first transistor including a non-overlapping area that does not partially overlap with the gate electrode of the first transistor such that the active layer of the first transistor is partially exposed to the back light, and the active layer of the second transistor completely overlapping with the gate electrode of the second transistor such that the active layer of the second transistor is shielded from the back light.

11. The liquid crystal display of claim 10, wherein external light is incident from above the ring oscillator, and a light-shielding portion for shielding the external light is formed over the first transistor and the second transistor.

12. The liquid crystal display of claim 10, wherein an overlap length of the gate electrode of the first transistor and the source electrode and an overlap length of the gate electrode of the first transistor and the drain electrode are set to be minimum to acquire processing margins, respectively.

13. The liquid crystal display of claim 10, wherein the gate electrode of the second transistor includes a shield area extending from the active layer of the second transistor by over 10 μm.

14. The liquid crystal display of claim 1, wherein external light is incident from above the ring oscillator, wherein each of the inverters includes a first transistor and a second transistor, which are serially connected to each other, and wherein a light-shielding portion for shielding the external light is formed over the second transistor.

15. The liquid crystal display of claim 14, further comprising a light-emitting unit supplying back light from below the ring oscillator, wherein each of the first transistor and the second transistor has a gate electrode, an active layer disposed over the gate electrode, and a source electrode and a drain electrode disposed on the active layer, and the active layer completely overlapping with the gate electrode.

16. The liquid crystal display of claim 14, wherein the gate electrodes of the first and second transistors each include a shield area extending from the active layer by over 10 μm.

17. A driving method of a liquid crystal display, the driving method comprising:
providing a liquid crystal display comprising a photo sensor including a ring oscillator having cascade-connected inverters, wherein an output signal of the ring oscillator has a frequency varying according to luminance of ambient light;
supplying the ring oscillator with the ambient light; and
measuring the luminance of ambient light using the frequency.

18. The driving method of claim 17, wherein each of the inverters includes a first transistor having an active layer into which ambient light is incident, and a second transistor having an active layer by which ambient light is shielded.

19. The driving method of claim 17, wherein the liquid crystal display further comprises a light-emitting unit supplying back light from below the ring oscillator, and after measuring the luminance of ambient light, the driving method further comprises compensating for the luminance of back light.

20. The driving method of claim 17, wherein the liquid crystal display includes a plurality of photo sensors arranged therein and external light is incident from above the oscillator, and measuring the luminance of ambient light further comprises determining a touch point on the liquid crystal display after measuring the luminance of ambient light by each of the plurality of photo sensors.
